(19) United States
(12) Patent Application Publication
(10) Pub. No.: US 2012/0024647 A1
(43) Pub. Date: Feb. 2, 2012

(54) CYLINDER APPARATUS, METHOD FOR MANUFACTURING THE SAME, AND SHOCK ABSORBER

(76) Inventor: Makoto NISHIMURA, Tokyo (JP)

(21) Appl. No.: 12/888,730

(22) Filed: Sep. 23, 2010

(30) Foreign Application Priority Data
Jul. 30, 2010 (JP) 171908/2010

(51) Int. Cl. F16F 9/32; F16J 10/02; B21D 9/05; F16F 9/24

(52) U.S. Cl. 188/322.19; 92/169.1; 72/370.04

(57) ABSTRACT

The present invention provides a cylinder apparatus processing method capable of preventing a base shell from bending which otherwise would be caused due to a residual stress generated when the base shell is processed. The cylinder apparatus processing method comprises securely holding an outer diameter of the base shell 1 with a mandrel 5 inserted therethrough with use of a holder die 4, and forming a recess 2 on the base shell 1 by locally applying crush processing (cold working) to an upper position of the base shell 1 with use of a press die 6 and concurrently forming an impression 21 of a bend prevention die 7 at a lower position of the outer diameter of the base shell 1 by a reactive force R to a processing force F applied by the press die 6 and received by the bend prevention die 7. According to this method, it is possible to have closer values for a residual stress generated at the recess 2 of the base shell 1 and a residual stress generated at the impression 21 formed at a position opposite from the recess 2. As a result, it is possible to have closer values for the residual stresses generated at the diametrically both sides of the base shell 1, thereby effectively preventing the base shell 1 from bending.

### BACKGROUND OF THE INVENTION

The present invention relates to a cylinder apparatus, a method for manufacturing the cylinder apparatus, and a shock absorber.

For example, Japanese Patent Public Disclosure Hei 5-263860 discloses a strut-type cylinder apparatus having an outer tube provided with a recess for preventing interference with other vehicle members disposed near the cylinder apparatus.

However, in a cylinder apparatus having an outer tube provided with, for example, a recess, the outer tube may be deformed due to a change in the residual stress at the recess formed on the outer tube.

### SUMMARY OF THE INVENTION

Therefore, an object of the present invention is to provide a cylinder apparatus using an outer tube capable of being manufactured with improved precision.

To achieve the forgoing and other objects, the present invention provides a cylinder apparatus including a cylindrical outer tube having a recess recessed from a radial one side on a side surface thereof, and a residual stress adjustment portion on the side surface thereof at a position radially opposite from the recess. A residual stress value of the residual stress adjustment portion is closer to a residual stress value of the recess than a residual stress value of a portion surrounding the residual stress adjustment portion is to the residual stress value of the recess.

### BRIEF DESCRIPTION OF THE DRAWINGS

FIG. 1 illustrates application of crush processing to a base shell with use of a crush die according to an embodiment of the present invention, and is a cross-sectional view of the base shell taken along the axis of the base shell;

FIG. 2 is a cross-sectional view taken along line A-A shown in FIG. 1;

FIG. 3 illustrates a first window or a second window formed at an upper die or a lower die;

FIG. 4 is a cross-sectional view of a surface including a recess and an impression formed on the base shell, taken along the axis of the base shell;

FIG. 5 is a perspective view illustrating the recess formed on the base shell;

FIG. 6 is a perspective view illustrating the impression of a bend prevention die formed on the base shell; and

FIG. 7 is a vertical cross-sectional view of a cylinder apparatus to which the present embodiment is applied.

### DETAILED DESCRIPTION OF THE INVENTION

An embodiment of the present invention will be described with reference to the accompanying drawings. Here, first, an object of the present embodiment will be described in detail.

In a strut-type suspension, it is advantageous to reduce an offset amount between a strut axis and a load input axis as much as possible, in terms of improvement of a ride comfort of a vehicle such as an automobile. A reduction in an offset amount between a strut axis and a load input axis can be realized by erecting (vertically setting up) the strut axis, which, however, causes a problem about interference between a cylinder apparatus constituting the strut and a tire. Therefore, as a measure for preventing interference with a tire, there is known a cylinder apparatus having an outer tube, i.e., a member which will be herein referred to as “base shell”, at which a recess is formed for avoiding a contact with a tire. However, in a strut-type suspension, an inner tube, in which a piston of a twin-tube-type cylinder apparatus slides, tends to have an increased inner diameter for improving the damping force characteristic thereof. According to this increase, a space for a reservoir chamber defined between the base shell and the inner tube, i.e., a space between the base shell and the inner tube tends to be reduced, which leads to a demand for strict processing procession to the recess formed on the base shell. In the method of pressing the base shell with a die from the radially outer side in order to form the recess, the required high processing precision can be satisfied by inserting a mandrel in the inner circumference of the base shell, and then pressing the base shell with a large force from the radially outer direction. However, a change in the residual stress due to the recess when the recess is formed on the side surface of the base shell may cause the base shell to be warped (the central axis of the cylinder to be bent). With the aim of solving this problem, the following description of the present embodiment will introduce an example of the processing method for forming the recess to the outer tube with strict processing precision and an example of a cylinder apparatus using the thus-formed outer tube.

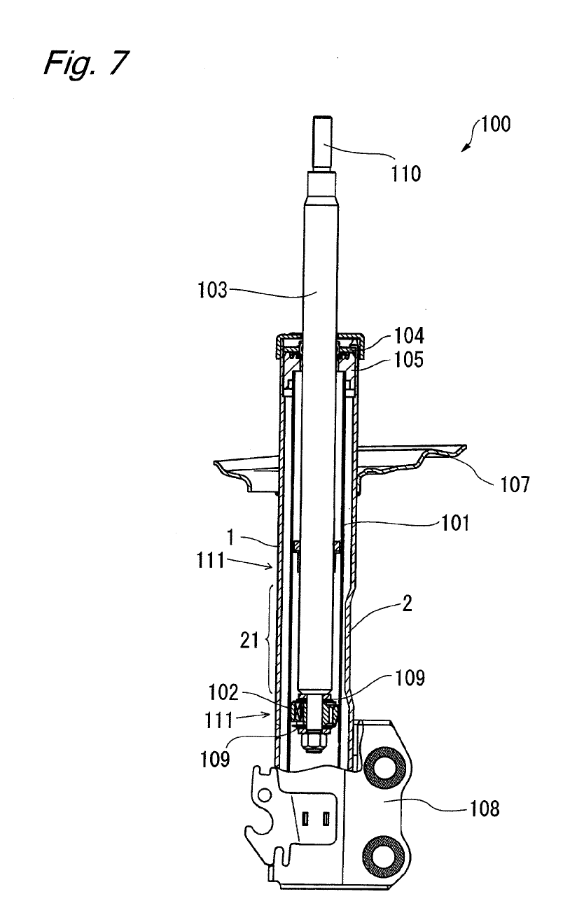

First, FIG. 7 is a cross-sectional view illustrating an overall structure of a cylinder apparatus 100 employing the present embodiment.

The cylinder apparatus 100 is generally constituted by a base shell 1 serving as an outer tube, an inner tube 101 as an inner tube coaxially disposed in the base shell 1, a piston 102 configured to slide in the inner tube, and a piston rod 103 having one end connected to the piston 102 and the other end protruding from one end of the base shell 1 by penetrating through a rod guide 105 having a seal 104. Oil and gas are sealingly contained in the base shell 1 as operating fluid.

The operating fluid may be embodied by only gas such as air or nitrogen, or may be embodied by liquid such as water containing an additive.

A spring sheet 107 is fittedly attached around the outer circumference of the base shell 1 for mounting a spring for suspension between the cylinder apparatus 100 and a vehicle such as an automobile. A bracket 108 is attached to the lower end of the base shell 1 for attaching the cylinder apparatus 100 to a spindle of a wheel.

Damping valves 109 are disposed at the upper and lower end surfaces of the piston 102 for generating a damping force.

A bolt portion 110 is formed at the tip of the other end of the piston rod 103 for attaching the cylinder apparatus 100 to a vehicle body through a mount.

A recess 2 is formed on the outer circumference of the base shell 1 for preventing interference with a wheel when the cylinder apparatus 100 is mounted on the vehicle body. Further, an impression 21, which serves as a residual stress adjustment portion of the present invention, is formed at a position radially opposite from the recess 2 of the base shell 1. Apparently, this impression 21 cannot be distinguished from a surrounding portion 111 which surrounds the impression 21, and a step is generated along the outer circumference of the impression 21 when a high pressure is applied thereto (a step is generated along a boundary between the impression 21 and the surrounding portion 111). However, the impression 21 is too inconspicuous to be noticed when the cylinder apparatus 100 is coated or painted. In other words, in the area of the impression (residual stress adjustment portion) 21, the outer circumferential surface of the base shell 1 is substantially undeformed relative to the cylindrical portion surrounding the impression 21.

Further, in the area of the impression (residual stress adjustment portion) 21, the inner circumferential surface of the base shell 1 is substantially undeformed respective to the cylindrical portion surrounding the impression 21.

In the present embodiment, the recess 2 is formed for the purpose of preventing interference with a wheel. However, the recess 2 may be formed at the same position or a different position for the purpose of avoiding a brake hose, a sensor, a suspension arm or a stabilizer. In this case, the shape of the recess 2 may vary according to an avoided member.

In the following, a description will be given of a method for processing a shock absorber (cylinder apparatus) constituting a strut of a strut-type suspension. More specifically, a description will be given of a method for forming the recess 2 at the base shell 1 of a twin-tube-type hydraulic shock absorber for preventing interference with a tire.

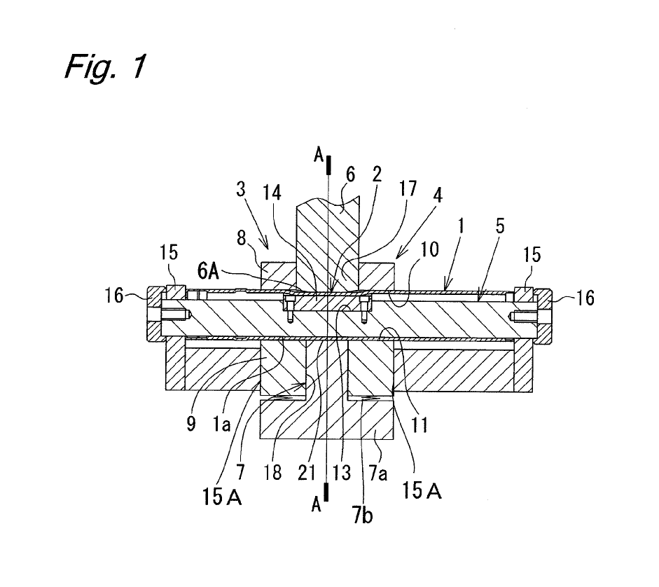

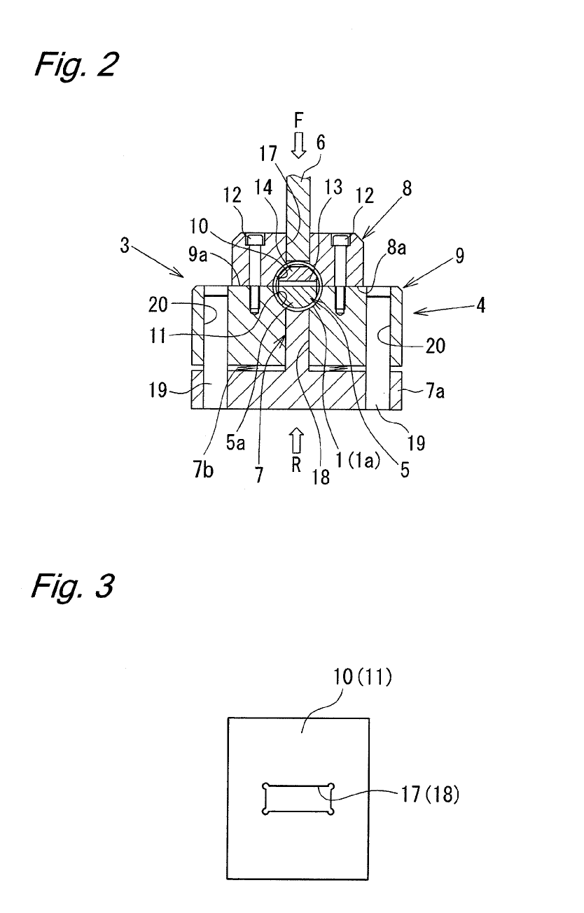

Referring to FIGS. 1 and 2, a description will be given of a crush die 3 which is used for crush processing to form the recess 2 at the base shell 1 of the cylinder apparatus 100. The crush die 3 includes a holder die 4, a mandrel 5, a press die 6, and a bend prevention die 7. The holder die 4 is divided into an upper die 8 and a lower die 9. The base shell 1 is held by the pair of dies 8 and 9 at a held portion 1a of the base shell 1, i.e., the outer diameter (outer circumferential surface) of the substantially central portion of the base shell 1 in the axial direction thereof. Further, a holding surface 10 is formed on a matching surface 8a of the upper die 8. The holding surface 10 has a shape of a half divided inner cylinder so as to correspond to the upper portion of the outer diameter of the held portion 1a of the base shell 1 shown in FIGS. 1 and 2. Further, a holding surface 11 is formed on a matching surface 9a of the lower die 9. The holding surface 11 has a shape of a half divided inner cylinder so as to correspond to the lower portion of the outer circumference of the held portion 1a of the base shell 1 shown in FIGS. 1 and 2.

The holder die 4 is configured to hold the base shell 1 while in contact with the whole circumference of the outer diameter (outer circumferential surface) of the held portion 1a of the base shell 1 by tightening fastening bolts 12 to join the upper die 8 and the lower die 9 while the held portion 1a of the base shell 1 is sandwiched by the holding surface 10 of the upper die 8 and the holding surface 11 of the lower die 9. Secure holding of the outer diameter of the base shell 1 can be realized by configuring the die 4 so that the die 4 has an appropriate clearance (space) between the matching surface 8a of the upper die 8 and the matching surface 9a of the lower die 9 while the die 4 is in a state before tightening the fastening bolts 12. The drawings show a die for use in small production such as production of a prototype by way of example, and therefore the bolts 12 are used for fastening the upper die 8 and the lower die 9. For mass production, the upper die 8 and the lower die 9 may be disposed to be movable toward or away from each other with use of, for example, a hydraulic pressure, and the tube may be held with aid of the hydraulic pressure.

As shown in FIGS. 1 and 2, the mandrel 5 is formed into a column shape, and has such a cross-sectional shape that the left side and the right side (left side and right side as viewed in FIG. 2) of the upper portion thereof in the direction perpendicular to the axis, and a bottom 5a of the lower portion of the mandrel 5 can abut against the inner diameter (inner circumferential surface) of the held portion 1a of the base shell 1 held by the holder die 4. Further, the mandrel 5 includes a die attachment portion 13 formed by cutting out, in the direction perpendicular to the axis, the upper portion of the center of the mandrel 5 in the axial direction thereof (left-right direction as viewed in FIG. 1). An underside reception die 14 (flat surface of the mandrel 5) is attached to the die attachment portion 13 for receiving a load applied by the press die 6. Further, the both ends of the mandrel 5 are supported by mandrel guides 15 disposed in the front and at the back (the left and right as viewed in FIG. 1) of the lower die 9 of the holder die 4. The mandrel guides 15 include a slide portion 15A, and are disposed so as to be vertically movable relative to the lower die 9. Stoppers 16 are attached to the both end surfaces of the mandrel 5 inserted through the base shell 1, for preventing a movement of the mandrel 5 relative to the base shell 1 and the holder die 4. Further, a clearance is provided at the left side and the right side as viewed in FIG. 2 between the base shell 1 and the mandrel 5 for the purpose of facilitation of pullout of the mandrel 5 from the base shell 1.

The holder die 4 includes a first rectangular window 17 (refer to FIG. 3) having one side (upper side) open to the center of the top surface of the upper die 8, and the other side (lower side) open to the holder surface 10 of the upper die 8. The press die 6 is vertically slidably inserted in the first window 17 to face the underside reception die 14 via the side wall of the base shell 1. Further, the holder die 4 includes a second rectangular window 18 having one side (upper side) open to the holding surface 11 of the lower die 9, and the other side (lower side) open to the center of the bottom surface of the lower die 9. A bend prevention die 7 is inserted in the second window 18 so as to face the press die 6 via the base shell 1 with the mandrel inserted therethrough, in such a manner that the bend prevention die 7 is vertically movable relative to the lower die 9. Further, the lower die 9 is also borne by being vertically supported on a base 7a of the prevention die 7 by a spring 7b.

The bend prevention die 7 includes the base 7a having a top surface which faces the bottom surface of the lower die 9 of the holder die 4 with a predetermined space therebetween. A guide post 19 is erected at each of the four corners of the base 7a of the bend prevention die 7. The respective guide posts 19 are relatively movably inserted in respectively corresponding guide holes 20 formed at the lower die 9 of the holder die 4. Due to this arrangement, the holder die 4 is supported in a floating manner so as to be vertically movable relative to the bend prevention die 7 while the base shell 1 shown in FIGS. 1 and 2 is held by the holder die 4. The crush die 3 may be configured such that a guide bush (sleeve) is provided at each of the guide holes 20, and each of the guide posts 19 is inserted in each of the guide bushes. In this case, it becomes possible to reduce sliding resistance of the holder die 4 against the guide posts 19 to more smoothly move the holder die 4 in the vertical direction.

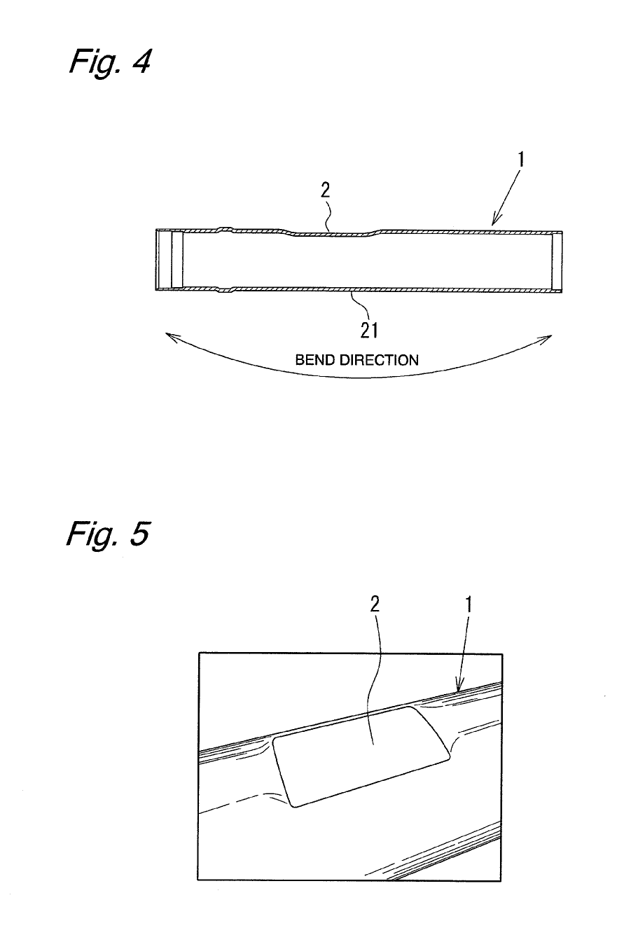

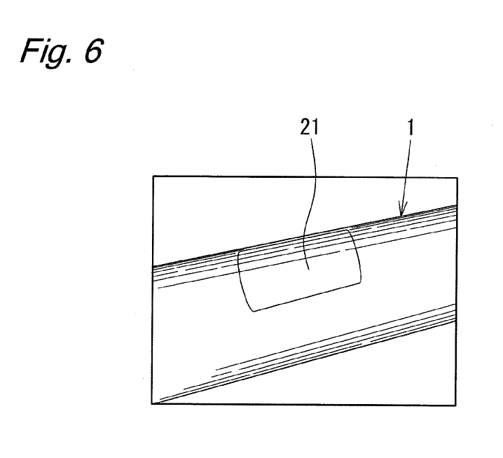

As shown in FIG. 1, a tapered portion 6A is formed around the tip surface of the press die 6. The crush die 3 is configured such that the substantial area (hereinafter referred to as “processing effective area of the press die 6”) of the molding surface of the press die 6 not including the tapered portion 6A is substantially equal to the substantial area (hereafter referred to as “reception area of the bend prevention die 7”) of the reception surface of the bend prevention die 7. Due to this arrangement, a processing force F (indicated by the down-pointing arrow in FIG. 2) applied from the press die 6 acting on the base shell 1 becomes equal to a reactive force R (up-pointing arrow in FIG. 2) applied from the bend prevention die 7. Therefore, in the present embodiment, a substantially equal relationship is established between a residual stress generated at the recess 2 (refer to FIG. 5) formed at the base shell 1 by the crush processing with use of the press die 6, and a residual stress generated at an impression 21 (refer to FIG. 6) of the bend prevention die 7 which is formed at the opposite side of the base shell 1 from the recess 2 (the position displaced from the recess 2 by an angle of 180° in the circumferential direction of the base shell 1) by the reactive force to the processing force received by the bend prevention die 7 during the crush processing. As a result, residual stresses generated at the both sides of the base shell 1 in the diametrical direction (vertical direction as viewed in FIG. 4) of the base shell 1 have closer values, whereby a formation of a bend of the base shell 1 as shown in FIG. 4 can be prevented. Typically, the impression 21 has a substantially identical shape to the shape of the recess 2, as shown in FIGS. 6 and 5. For actual manufacturing of a product, an actual area and processing force F of the press die 6 is finely adjusted while a product test is conducted, thereby achieving a tube with little warp or deformation thereof.

The present embodiment functions as follows. First, the held portion 1a of the base shell 1 with the mandrel 5 inserted therethrough is sandwiched by the holding surface 10 of the upper die 8 and the holding surface 11 of the lower die 9, and then the upper die 8 and the lower die 9 are joined together by tightening the fastening bolts 12. As a result, the outer diameter (outer circumferential surface) of the held portion 1a of the base shell 1 is securely held by the holder die 4. Attachment of the respective stoppers 16 at the both sides of the mandrel 5 supported by the pair of mandrel guides 15 enables proper positioning of the mandrel 5 relative to the holder die 4. As shown in FIG. 2, when the base shell 1 is held by the holder die 4, the press die 6 and the bend prevention die 7 vertically face each other through the base shell 1, and the bend prevention die 7 abuts against the lower portion of the outer diameter of the held portion 1a of the base shell 1. Further, the holder die 4 is supported by the bend prevention die 7 in a floating manner.

In this state, crush processing is locally applied to the upper portion of the outer diameter of the held portion 1a of the base shell 1 by pressing it by the press die 6 with the processing force F of 20 to 30 tons while the corresponding portion of the base shell 1 is received by a pressure reception portion formed on the flat surface of the underside reception die 14 of the mandrel 5, thereby providing the base shell 1 with the recess 2 constituted by an impression of a rectangular flat surface as shown in FIG. 5. At the same time, the impression 21 of the bend prevention die 7 as shown in FIG. 6 is formed at the portion opposite of the base shell 1 from the recess 2, i.e., the portion against which the bend prevention die 7 abuts, due to the reactive force R to the processing force F of the press die 6 received by the bend prevention die 7. In the present embodiment, the outer diameter (outer circumferential surface) of the base shell 1 is securely held by the holder die 4, and the processing effective area of the press die 6 and the reception area of the bend prevention die 7 are sized so as to be equal to each other. In addition, the crush processing is performed as cold working. As a result, it is possible to achieve application of the reactive force R (R=20 to 30 tons), which has strength equal to the pressing force F applied by the press die 6, from the bend prevention die 7 to the base shell 1.

Therefore, the base shell 1 can be formed in such a manner that the residual stress generated at the recess 2 (refer to FIG. 5) of the base shell 1 and the residual stress generated at the impression 21 (refer to FIG. 6) formed opposite from the recess 2 become closer to each other. Further, in the present embodiment, the processing is performed in a cold condition, whereby it is highly unlikely to receive an influence of a stress change due to a heat during the processing.

Stress measurement was actually conducted, the result of which will be now described. The above-mentioned processing method was applied to an electric resistance welded tube as the base shell 1, which is made of a carbon steel pipe for machine structural use (STKM13A) and has an outer diameter of 60 mm, a thickness of 3 mm and a length of 370 mm. After the processing, the axial stresses were measured by the X-ray diffraction method. As a result, the stress at the surrounding portion 111 around the impression 21 was 96 Mpa, and the stress at the recess 2 was −83 to 29 Mpa. On the other hand, the stress at the impression 21 (residual stress adjustment portion) was −16 to 32 Mpa. This result indicates that the stresses at the recess 2 and the impression 21 each were changed to a stress of the compression side, compared to the stress at the unprocessed portion (surrounding portion 111). Consequently, the residual stress generated at the impression 21 (refer to FIG. 6) formed at the opposite side from the recess 2 became closer to the residua stress generated at the recess 2 (refer to FIG. 5) of the base shell 1, whereby the outer tube only had extremely little warp of 0.05 mm.

In this way, according to the present invention, it is possible to have closer values for the residual stresses generated at the both sides of the base shell 1 in the diametrical direction thereof (vertical direction as viewed in FIG. 4), and thereby possible to effectively prevent the base shell 1 from bending as shown in FIG. 4.

The cylinder apparatus using the base shell 1 prepared in the above-mentioned manner is manufactured as follows. First, one end side of the base shell 1 is closed, for example, by welding a bottom cap thereto or by performing closing processing. The inner tube 102 is inserted in the base shell 1. Then, after oil is supplied into the base shell 1 and the inner tube 102, the piston rod assy is assembled by penetratingly inserting the piston rod 103 with the piston 102 attached thereto through the seal 104 and the rod guide 105. This piston rod assy is inserted in the base shell 1 and the inner tube 102, and the other end side of the base shell 1 is swaged, thereby completing manufacturing of a shock absorber for an automobile as the cylinder apparatus 100.

The present embodiment provides the following advantageous effects.

According to the present embodiment, while the outer diameter (outer circumferential surface) of the base shell 1 with the mandrel 5 inserted therethrough is securely held by the holder die 4, crush processing (cold working) is locally applied to the upper portion of the base shell 1 with use of the press die 6 to form the recess 2 at the base shell 1, and at the same time, the impression 21 of the bend prevention die 7 is formed at the lower portion of the outer diameter of the base shell 1, i.e., the opposite side from the recess 2 due to the reactive force to the processing force which is applied by the press die 6 and is received by the bend prevention die 7.

Therefore, it can be prevented that the pressing force F applied by the press die 6 is consumed for, for example, elastic deformation of the base shell 1, due to the secure holding of the outer diameter of the base shell 1 by the holder die 4. In addition, setting the same width for the processing effective area of the press die 6 and the reception area of the bend prevention die 7 enables the processing force F applied by the press die 6 to the base shell 1 and the reactive force R from the bend prevention die 7 to become equal to each other.

This arrangement enables the residual stress generated at the recess 2 of the base shell 1 and the residual stress generated at the impression 21 formed at the opposite side from the recess 2 to become substantially equal to each other. As a result, the residual stresses generated at the both sides of the base shell 1 in the diametrical direction can have closer values, thereby effectively preventing the base shell 1 from bending.

In the present embodiment, the present invention is embodied as a processing method for forming a recess at a base shell by way of example. However, the present invention is not limited thereto. For example, the present invention may be applied as a processing method for providing a base shell with a spring sheet fixation portion or a protrusion required for mounting of a bracket to be formed on the base shell. In this case, a protrusion is formed at the underside reception die 14 of the mandrel 5, and a recess is formed at the press die 6. This embodiment can also bring about the same advantageous effects as the present embodiment.

It should be noted that the cylinder apparatus according to the present invention can be applied as a cylinder apparatus of an electromagnetic suspension equipped with a ball screw and a linear motor therein. According to the present embodiment, it is possible to provide a cylinder apparatus with use of an outer tube that can be manufactured with improved precision.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority to Japanese Patent Application No. 2010-171908 filed on Jul. 30, 2010. The entire disclosure of Japanese Patent Application No. 2010-171908 filed on Jul. 30, 2010 including specification, claims, drawings and summary is incorporated herein by reference in its entirety.

What is claimed is:

1. A cylinder apparatus including a cylindrical outer tube, wherein:
the outer tube comprises a recess recessed from a radial one side on a side surface thereof, and a residual stress adjustment portion on the side surface thereof at a position radially opposite from the recess; and
a residual stress value of the residual stress adjustment portion is closer to a residual stress value of the recess than a residual stress value of a portion surrounding the residual stress adjustment portion is to the residual stress value of the recess.

2. The cylinder apparatus according to claim 1, wherein, at the residual stress adjustment portion of the outer tube, at least an inner circumferential surface thereof is substantially undeformed relative to a cylindrical portion around the residual stress adjustment portion.

3. The cylinder apparatus according to claim 1, wherein, at the residual stress adjustment portion of the outer tube, an outer circumferential surface thereof is substantially undeformed relative to a cylindrical portion around the residual stress adjustment portion.

4. The cylinder apparatus according to claim 1, wherein a shape of a portion of the outer tube where the recess is formed, and a shape of a portion of the outer tube where the residual stress adjustment portion is formed are substantially identical.

5. The cylinder apparatus according to claim 1, the axial residual stress value of the residual stress adjustment portion is a value of a compression side, compared to the axial residual value of the surrounding portion.

6. A shock absorber for an automobile, comprising:
a cylindrical outer tube sealingly containing operating fluid therein;
an inner tube disposed in the outer tube;
a piston slidably disposed in the inner tube;
a piston rod having one end connected to the piston, and the other end protruding from the cylinder;
a recess formed on a part of a side surface of the outer tube in the circumferential direction; and
a residual stress adjustment portion formed on the side surface of the outer tube at a position radially opposite from the recess, the residual stress adjustment portion having a residual stress value closer to a residual stress value of the recess than a residual stress value of a portion surrounding the residual stress adjustment potion is to the residual stress value of the recess.

7. The shock absorber for the automobile according to claim 6, wherein, at the residual stress adjustment portion of the outer tube, at least an inner circumferential surface thereof is substantially undeformed relative to a cylindrical portion around the residual stress adjustment portion.

8. The shock absorber for the automobile according to claim 6, wherein, at the residual stress adjustment portion of the outer tube, an outer circumferential surface thereof is substantially undeformed relative to a cylindrical portion around the residual stress adjustment portion.

9. The shock absorber for the automobile according to claim 6, wherein a shape of a portion of the outer tube where the recess is formed, and a shape of a portion of the outer tube where the residual stress adjustment portion is formed are substantially identical.

10. The shock absorber for the automobile according to claim 6, the axial residual stress value of the residual stress adjustment portion is a value of a compression side, compared to the axial residual value of the surrounding portion.

11. A cylinder apparatus manufacturing method for manufacturing a cylinder apparatus including a cylindrical outer tube, the outer tube having a side surface provided with a recess recessed from radial one side, the method comprising:
inserting a mandrel inside the outer tube, the mandrel having a column shape including a processing reception surface at a part thereof in an axial direction; and
forming the recess on the side surface of outer tube by applying crush processing to the outer tube with a press die, the crush processing comprising pressing a position of the outer tube which faces the processing reception surface of the mandrel with use of the press die from a radially outer side, and concurrently pressing the outer tube with use of a bend prevention die disposed at a position opposite of the outer tube from the press die.

12. The cylinder apparatus manufacturing method according to claim 11, wherein the crush processing is applied in such a state that an outer diameter of the outer tube is radially held from the direction of the outer tube perpendicular to a movement direction of the press die.

13. The cylinder apparatus manufacturing method according to claim 12, wherein:
the holding is performed with use of a divided holder die;
a first window is provided at the holder die at a position facing the processing reception surface of the mandrel; and
the crush processing is performed by inserting the press die through the first window, and inserting the bend prevention die through a second window formed at a position opposite from the first window of the divided holder die.

14. The cylinder apparatus manufacturing method according to claim 11, wherein a shape of a portion of the outer tube processed by the press die, and a shape of a pressed portion of the outer tube pressed by the bend prevention die are substantially identical.

15. The cylinder apparatus manufacturing method according to claim 11, wherein:
the holder die is divided into a first die and a second die; and
the second die of the holder die and the bend prevention die are positionally limited by a guide post disposed to extend through the second die and the bend prevention die in a movement direction of the press die.

16. The cylinder apparatus manufacturing method according to claim 11, wherein the processing reception surface of the mandrel is a flat surface.

17. The cylinder apparatus manufacturing method according to claim 11, the bend prevention die has a processing surface having a same curvature radius as a curvature radius of the side surface of the outer tube.
